(19) United States
(12) Patent Application Publication
(10) Pub. No.: US 2024/0020218 A1
(43) Pub. Date: Jan. 18, 2024

(54) END-TO-END TESTING IN A MULTI-CLOUD COMPUTING SYSTEM

(71) Applicant: VMware, Inc., Palo Alto, CA (US)

(72) Inventors: Miroslav SHTARBEV, Sofia (BG); Tanya TOSHEVA, Sofia (BG); Desislava NIKOLOVA, Sofia (BG); Petko CHOLAKOV, Sofia (BG)

(21) Appl. No.: 17/867,550

(22) Filed: Jul. 18, 2022

(51) Int. Cl. G06F 11/36; G06F 9/455

(52) U.S. Cl. CPC G06F 11/3664; G06F 9/45558; G06F 11/3688; G06F 2009/45595; G06F 2009/45591

(57) ABSTRACT

An example method of end-to-end testing in a multi-cloud environment having a public cloud in communication through a messaging fabric with a data center, the method including: deploying, by a testbed management service executing in the public cloud, a testbed in the data center, the testbed including an agent platform appliance and endpoint software executing on virtualized hosts of the data center, the agent platform appliance in communication with the end point software and the messaging fabric of the public cloud; executing, by a test service in the public cloud, tests against the testbed; and verifying, in response to results of the tests, operation of cloud services executing in the public cloud and configured to interact with the endpoint software.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the SDDC spans across an on-premises data center and a public cloud. Running applications across multiple clouds can engender complexity in setup, management, and operations. Further, there is a need for centralized control and management of applications across the different clouds. With this centralized control and management, there is a need for comprehensive testing to verify that the management software is working properly with the software being managed.

### SUMMARY

In an embodiment, a method of end-to-end testing in a multi-cloud environment having a public cloud in communication through a messaging fabric with a data center is described. The method includes: deploying, by a testbed management service executing in the public cloud, a testbed in the data center, the testbed including an agent platform appliance and endpoint software executing on virtualized hosts of the data center, the agent platform appliance in communication with the end point software and the messaging fabric of the public cloud; executing, by a test service in the public cloud, tests against the testbed; and verifying, in response to results of the tests, operation of cloud services executing in the public cloud and configured to interact with the endpoint software.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a cloud control plane implemented in a public cloud and an SDDC that is managed through the cloud control plane, according to embodiments.

FIG. 2 is a block diagram of an SDDC in which embodiments described herein may be implemented.

FIG. 3 is a block diagram depicting end-to-end testing in a multi-cloud environment according to embodiments.

FIG. 4 is a flow diagram depicting a method of end-to-end testing in a multi-cloud environment according to an embodiment.

### DETAILED DESCRIPTION

End-to-end testing in a multi-cloud computing system is described. In embodiments, the multi-cloud computing system includes a public cloud in communication with one or more data centers through a message fabric. The public cloud includes cloud services executing therein that are configured to interact with endpoint software executing in the data centers. For example, an entitlement service executing in the public cloud is configured to interact with virtualization management software executing in a data center for the purpose of applying subscription(s) to the virtualization management software. The subscription(s) enable features of the virtualization management software in the context of managing virtualization software (e.g., hypervisors) installed on hosts of the data center. In embodiments, the cloud services establish connections with the endpoint software using an agent platform appliance executing in the data center. The agent platform appliance and the cloud services communicate through the messaging fabric, as opposed to a virtual private network (VPN) or similar private connection.

The agent platform appliance, the endpoint software, and the virtualization software on the hosts are separate software components that can be separately upgraded to newer versions over time. Upgrading one or more of such components, however, may affect the ability of the cloud services to interact with the endpoint software. In embodiments, an end-to-end testing technique includes deploying a testbed in a data center, such as a data center external to the production environment. The public cloud includes a testbed management service configured to deploy the testbed in the data center. The testbed includes an agent platform appliance and endpoint software executing on virtualized hosts of the data center. For example, the testbed management service can deploy the agent platform appliance and the endpoint software at a selected version that may be different from the version of such components in the production environment. The agent platform appliance is configured for communication with the public cloud through the messaging fabric. A test service executing in the public cloud executes tests against the testbed. The test service verifies that the cloud services can interact with the endpoint software and operate correctly. The upgrades can then be performed in the production environment having been validated by the end-to-end testing technique. These and further embodiments are described below with respect to the drawings.

One or more embodiments employ a cloud control plane for managing the configuration of SDDCs, which may be of different types and which may be deployed across different geographical regions, according to a desired state of the SDDC defined in a declarative document referred to herein as a desired state document. The cloud control plane is responsible for generating the desired state and specifying configuration operations to be carried out in the SDDCs according to the desired state. Thereafter, configuration agents running locally in the SDDCs establish cloud inbound connections with the cloud control plane to acquire the desired state and the configuration operations to be carried out, and delegate the execution of these configuration operations to services running in a local SDDC control plane.

One or more embodiments provide a cloud platform from which various services, referred to herein as “cloud services” are delivered to the SDDCs through agents of the cloud services that are running in an appliance (referred to herein as an “agent platform appliance”). A cloud platform hosts containers and/or virtual machines (VMs) in which software components can execute, including cloud services and other services and databases as described herein. Cloud services are services provided from a public cloud to endpoint software executing in data centers such as the SDDCs. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the endpoint software of the SDDCs is carried out through the agent platform appliance using a messaging fabric, for example, through respective agents of the cloud services that are deployed on the agent platform appliance. The messaging fabric is software that exchanges messages between the cloud platform and agents in the agent platform appliance over the public network. The components of the messaging fabric are described below.

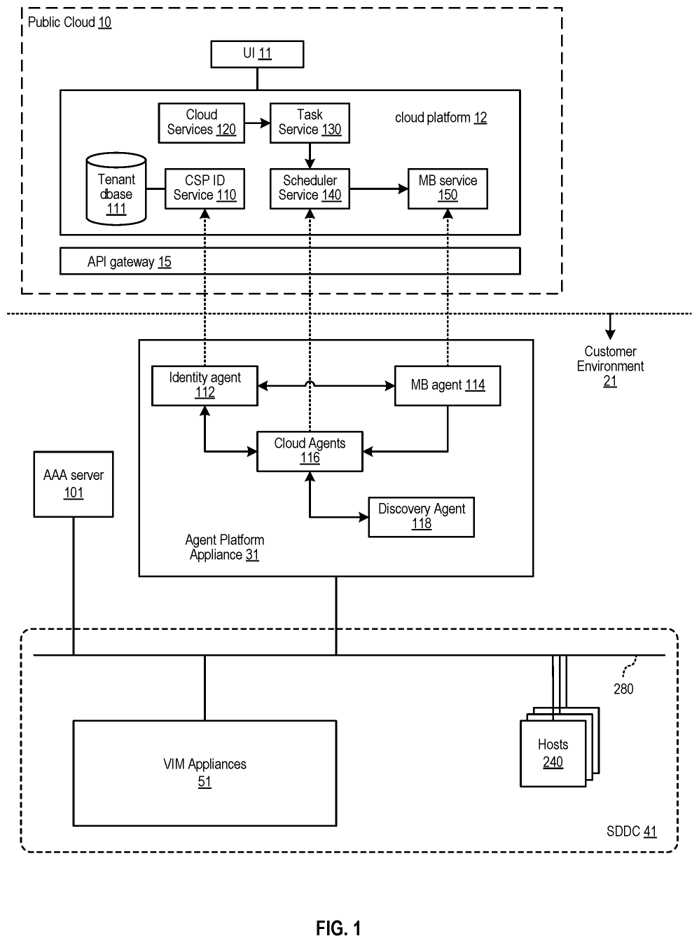

FIG. 1 is a block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 1 as UI 11.

An SDDC is depicted in FIG. 1 in a customer environment 21 and is a data center in communication with public cloud 10. In the customer environment, the SDDC is managed by respective virtual infrastructure management (VIM) appliances, e.g., VMware vCenter® server appliance and VMware NSX® server appliance. The VIM appliances in each customer environment communicate with an agent platform appliance, which hosts agents that communicate with cloud platform 12, e.g., via a messaging fabric over a public network, to deliver cloud services to the corresponding customer environment. For example, the VIM appliances 51 for managing the SDDCs in customer environment 21 communicate with agent platform appliance 31. VIM appliances 51 are an example of endpoint software executing in a data center that is a target of a cloud service executing in public cloud 10. Endpoint software is software executing in the data center with which a cloud service can interact as described further herein.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, the agent platform appliance and the management appliances are a VMs instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the agent platform appliance and the management appliances may be implemented as physical host computers having the conventional hardware platform described above.

FIG. 1 illustrates components of cloud platform 12 and agent platform appliance 31. The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs and the URL of the tenant's AAA (authentication, authorization and accounting) server 101, is collected, and user IDs and passwords for accessing (i.e., logging into) cloud platform 12 through UI 11 are set up for the tenant. The user IDs and passwords are associated with various users of the tenant's organization who are assigned different roles. The tenant profile information is stored in tenant dbase 111, and login credentials for the tenants are managed according to conventional techniques, e.g., Active Directory® or LDAP (Lightweight Directory Access Protocol).

In one embodiment, each of the cloud services is a microservice that is implemented as one or more container images executed on a virtual infrastructure of public cloud 10. The cloud services include a cloud service provider (CSP) ID service 110, cloud services 120, a task service 130, a scheduler service 140, and a message broker (MB) service 150. Similarly, each of the agents (cloud agents 116) deployed in the agent platform appliances is a microservice that is implemented as one or more container images executing in the agent platform appliances.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to a request from identity agent 112 if the request contains valid credentials.

In the embodiment, cloud services 120 manage endpoint software in customer environment 21. For example, cloud services 120 can include an entitlement service that entitles (applies a subscription entitlement to) VIM appliances and other software executing in customer environment 21. An entitlement service creates a task and makes an API call to task service 130 to perform the task (“entitlement task”). Task service 130 then schedules the task to be performed with scheduler service 140, which then creates a message containing the task to be performed and inserts the message in a message queue managed by MB service 150. After scheduling the task to be performed with scheduler service 140, task service 130 periodically polls scheduler service 140 for status of the scheduled task.

At predetermined time intervals, MB agent 114, which is deployed in agent platform appliance 31, makes an API call to MB service 150 to exchange messages that are queued in their respective queues (not shown), i.e., to transmit to MB service 150 messages MB agent 114 has in its queue and to receive from MB service 150 messages MB service 150 has in its queue. MB service 150 implements a messaging fabric on behalf of cloud platform 12 over which messages are exchanged between cloud platform (e.g., cloud services 120) and agent platform appliance 31 (e.g., cloud agents 116). Agent platform appliance 31 can register with cloud platform 12 by executing MB agent 114 in communication with MB service 150. In the embodiment, messages from MB service 150 are routed to respective cloud agents 116. For example, entitlement tasks can be routed to an entitlement agent. The entitlement agent issues a command to a management appliance that is targeted in the entitlement task (e.g., by invoking APIs of the management appliance) to perform the entitlement task and to check on the status of the entitlement task performed by the management appliance. When the task is completed by the management appliance, the entitlement agent invokes an API of scheduler service 140 to report the completion of the task. While the entitlement task is described as an example, those skilled in the art will appreciate that other tasks can be performed in a similar manner on behalf of other types of cloud services. Discovery agent 118 communicates with the management appliances of SDDC 41 to obtain authentication tokens for accessing the management appliances.

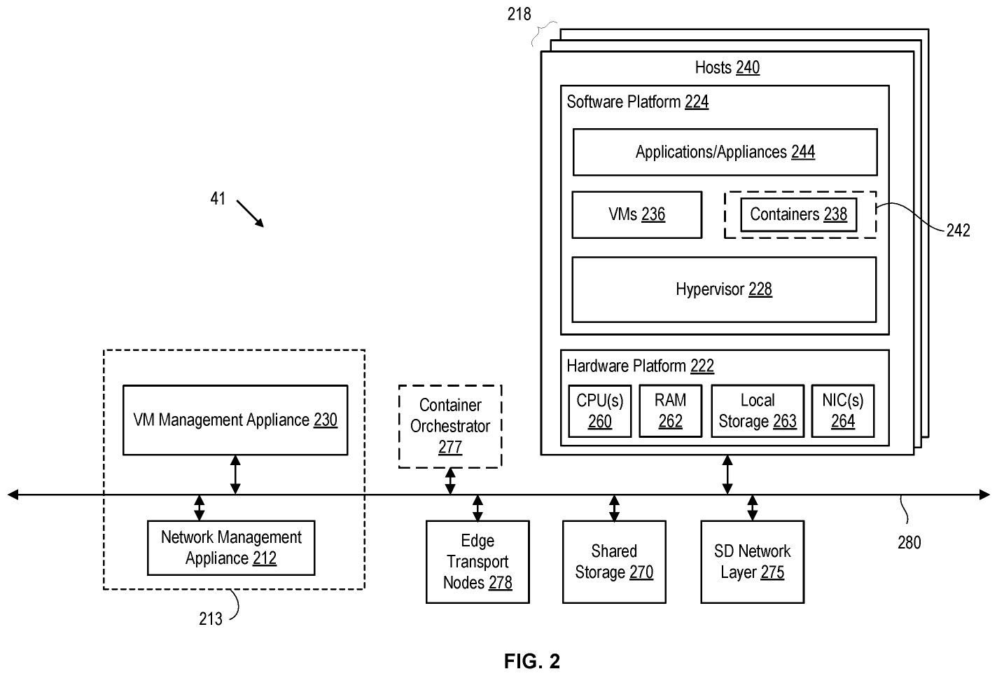

FIG. 2 is a block diagram of SDDC 41 in which embodiments described herein may be implemented. SDDC 41 includes a cluster of hosts 240 (“host cluster 218”) that may be constructed on hardware platforms such as an x86 architecture platforms. For purposes of clarity, only one host cluster 218 is shown. However, SDDC 41 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter MBA) through which input/output operations (IOs) are sent to shared storage 270 over a separate network (e.g., a fibre channel (FC) network), Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed. Applications and/or appliances 244 execute in VMs 236 and/or containers 238 (discussed below).

Host cluster 218 is configured with a software-defined (SD) network layer 275, SD network layer 275 includes logical network services executing on virtualized infrastructure in host duster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, SDDC 41 includes edge transport nodes 278 that provide an interface of host cluster 218 to a wide area network (WAN) (e.g., a corporate network, the public Internet, etc.).

VM management appliance 230 (e.g., one of VIM appliances 51 and an example of endpoint software described herein) is a physical or virtual server that manages host cluster 218 and the virtualization layer therein. VM management appliance 230 installs agent(s) in hypervisor 228 to add a host 240 as a managed entity, VM management appliance 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. VM management appliance 230 can manage more than one host cluster 218.

In an embodiment, SDDC 41 further includes a network management appliance 212 (e.g., another VIM appliance 51). Network management appliance 212 is a physical or virtual server that orchestrates SD network layer 275. In an embodiment, network management appliance 212 comprises one or more virtual servers deployed as VMs. Network management appliance 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network management appliance 212 and SD network layer 275 is a VMware NSX® platform made commercially available by VMware, Inc. of Palo Alto, CA.

VM management appliance 230 and network management appliance 212 comprise a virtual infrastructure (VI) control plane 213 of SDDC 41. VM management appliance 230 can include various VI services. The VI services include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments, SDDC 401 can include a container orchestrator 277. Container orchestrator 277 implements an orchestration control plane, such as Kubernetes®, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 277 can include one or more master servers configured to command and configure pod VM controllers in host cluster 218. Master server(s) can be physical computers attached to network 280 or VMs 236 in host cluster 218.

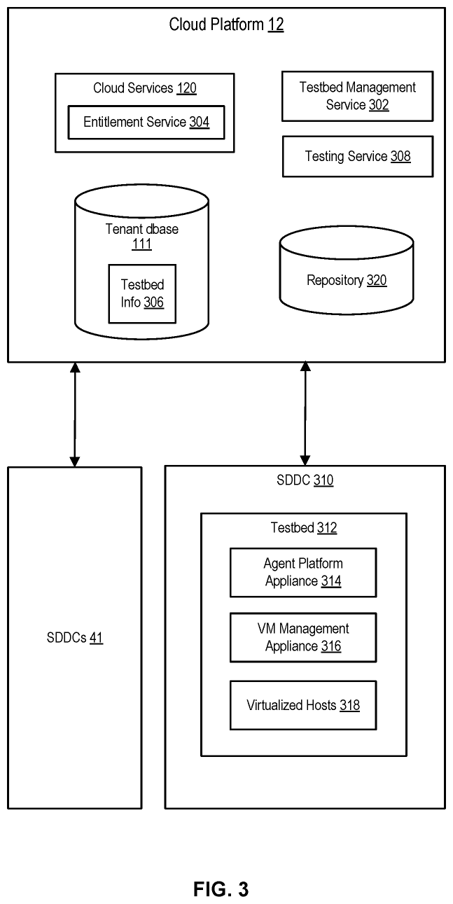

FIG. 3 is a block diagram depicting end-to-end testing in a multi-cloud environment according to embodiments. Some details of cloud platform 12 and SDDCs 41 are omitted for clarity. In the embodiment, cloud platform 12 includes a testbed management service 302, a testing service 308, and a repository 320. Testbed management service 302 is configured to deploy testbeds to a data center that can be used by testing service 308 to verify operation of cloud services 120 against the testbeds. In the embodiment, testbed management service 302 deploys testbeds to an SDDC 310 (e.g., such as an SDDC as shown in FIG. 2). SDDC 310 can be a separate data center from the customer SDDCs 41 (e.g., a development or testing environment outside of a production environment). A testbed 312 deployed in SDDC 310 can include agent platform appliance 314, VM management appliance 316, and virtualized hosts 318. VM management appliance 316 is an example of endpoint software executing on virtualized hosts 318 that can be tested. The software of testbed 312 can be selected from a plurality of versions for each component (e.g., development versions, production versions, beta versions, etc.). Repository 320 can store version information for each testbed component, as well as software installation packages or locations of such software installation packages for the different versions.

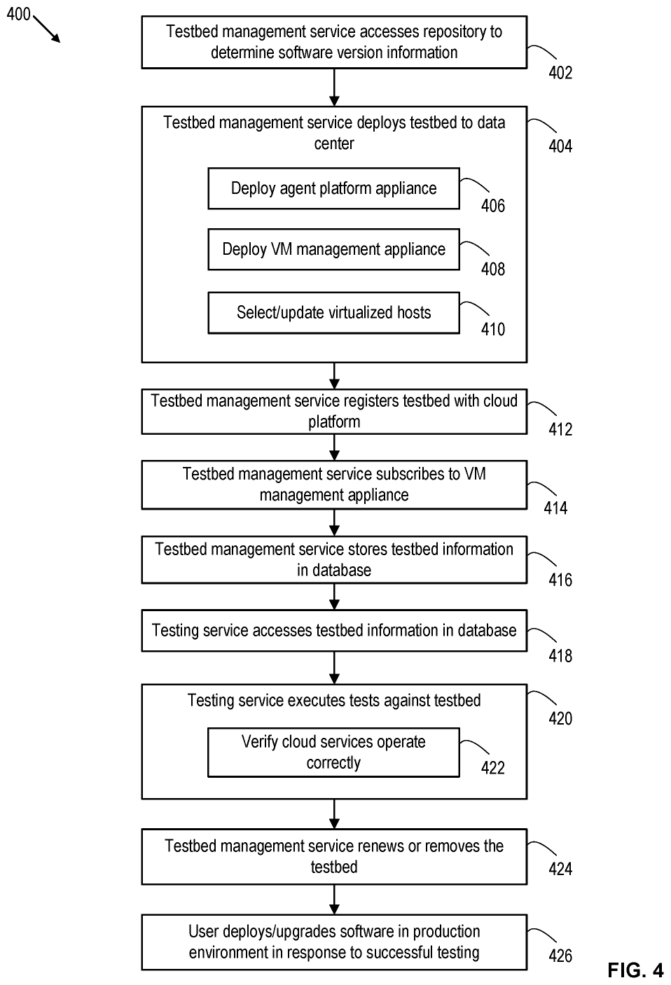

FIG. 4 is a flow diagram depicting a method 400 of end-to-end testing in a multi-cloud environment according to an embodiment. Method 400 can be understood with respect to the embodiment of FIG. 3. Method 400 begins at step 402, where tested management service 302 accesses repository 320 to determine software version information for a testbed. A user can interact with testbed management service 302 to select versions of components of the testbed based on what is to be testing (e.g., production environment versus development environment). At step 404, testbed management service 302 deploys a testbed 312 to a data center (e.g., SDDC 310). For example, at step 406, testbed management service 302 deploys agent platform appliance 314. At step 408, testbed management service 302 deploys VM management appliance 316 (or other endpoint software under test). At step 410, testbed management service 302 selects virtualized hosts for a cluster managed by VM management appliance 316. Testbed management service 302 can update virtualization software on the hosts if necessary based on the selected version information. In embodiments, testbed management service 302 deploys testbed 312 by interacting with a VM management appliance already deployed in SDDC 310 (e.g., as shown in FIG. 2).

At step 412, testbed management appliance 302 registers testbed 312 with cloud platform 12. For example, testbed management appliance 302 registers agent platform appliance 314 with cloud platform 12 in order to work with the messaging fabric and cloud services. That is, MB agent 114 is registered with MB service 150 to exchange messages over the public network. At step 414, testbed management appliance 302 subscribes to VM management appliance 316. For example, testbed management appliance 302 can use entitlement service 304 to perform entitlement of VM management appliance 316 (apply a subscription entitlement to VM management appliance 316). At step 416, testbed management service 302 stores testbed information 306 in a database (e.g., tenant dbase 111 or any other database).

At step 418, testing service 308 accesses testbed information 306 from the database. Testbed information 306 can include information describing components of testbed 312, version information of the components, information on how to connect to testbed 312, and the like. At step 420, testing service executes tests against testbed 312. For example, at step 422, testing service verifies cloud services 120 operate correctly with the software of testbed 312.

At step 424, testbed management service 302 can renew testbed 312 to keep it in place or can remove testbed 312 from the data center. For example, testbed 312 can be deployed so that it expires and is removed after a certain duration. Testbed management service 302 can renew testbed 312 and refresh the expiration period. At step 426, after successful testing, the user can deploy or upgrade the tested software (e.g., the software of the testbed) in a production environment (e.g., SDDCs 41).

Techniques for end-to-end testing in a multi-cloud system have been described. In embodiments, the multi-cloud system includes a public cloud having cloud services that interact with endpoint software executing in a data center. The cloud platform having the cloud services includes a messaging fabric that exchanges messages with an agent platform appliance executing in the data center. The cloud services can exchange messages through the messaging fabric with the agent platform appliance to establish connections with the endpoint software and interact with the endpoint software. As opposed to a direct connection, such as a VPN, such communication requires multiple independent software components, including the cloud services, the agent platform appliance, the endpoint software, and virtualization software of the virtualized hosts on which the endpoint software executes. Testing such communication can be vital to operation of the cloud services. The techniques described herein can deploy a testbed in a data center (e.g., outside of the production environment), which includes the agent platform appliance, endpoint software, and virtualization software on virtualized hosts. Operation of the cloud services with the endpoint software can be tested and verified outside of the production environment. For example, testing can be performed on upgraded versions of the agent platform appliance, the endpoint software, and/or the virtualization software with respect to that used in the production environment. Successful testing and validation can mitigate the risk of performing such software upgrades in the production environment.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of end-to-end testing in a multi-cloud environment having a public cloud in communication through a messaging fabric with a data center, the method comprising:
deploying, by a testbed management service executing in the public cloud, a testbed in the data center, the testbed including an agent platform appliance and endpoint software executing on virtualized hosts of the data center, the agent platform appliance in communication with the end point software and the messaging fabric of the public cloud;
executing, by a test service in the public cloud, tests against the testbed; and
verifying, in response to results of the tests, operation of cloud services executing in the public cloud and configured to interact with the endpoint software.

2. The method of claim 1, wherein the endpoint software includes a virtual machine (VM) management appliance, the VM management appliance managing virtualization software executing on the virtualized hosts.

3. The method of claim 1, further comprising:
registering the agent platform appliance with a cloud platform of the public cloud, the cloud platform including the cloud services, the testbed management service, the test service, and the messaging fabric.

4. The method of claim 1, further comprising:
applying, by the testbed management service in cooperation with an entitlement service executing in the public cloud, a subscription entitlement for a VM management server of the testbed, the VM management server managing virtualization software executing on the virtualized hosts.

5. The method of claim 1, further comprising:
storing, by the testbed management service in a database executing in the public cloud, information describing the testbed; and
obtaining, by the test service, the information when executing the tests against the testbed.

6. The method of claim 1, wherein the testbed management service installs virtualization software on the virtualized hosts.

7. The method of claim 1, wherein the testbed is configured to expire after a duration, and wherein the testbed management service is configured to renew the testbed prior to expiration for a new duration.

8. A non-transitory computer readable medium comprising instructions to be executed in a computing device to cause the computing device to carry out a method of end-to-end testing in a multi-cloud environment having a public cloud in communication through a messaging fabric with a data center, the method comprising:
deploying, by a testbed management service executing in the public cloud, a testbed in the data center, the testbed including an agent platform appliance and endpoint software executing on virtualized hosts of the data center, the agent platform appliance in communication with the end point software and the messaging fabric of the public cloud;
executing, by a test service in the public cloud, tests against the testbed; and
verifying, in response to results of the tests, operation of cloud services executing in the public cloud and configured to interact with the endpoint software.

9. The non-transitory computer readable medium of claim 8, wherein the endpoint software includes a virtual machine (VM) management appliance, the VM management appliance managing virtualization software executing on the virtualized hosts.

10. The non-transitory computer readable medium of claim 8, further comprising:
registering the agent platform appliance with a cloud platform of the public cloud, the cloud platform including the cloud services, the testbed management service, the test service, and the messaging fabric.

11. The non-transitory computer readable medium of claim 8, further comprising:
applying, by the testbed management service in cooperation with an entitlement service executing in the public cloud, a subscription entitlement for a VM management server of the testbed, the VM management server managing virtualization software executing on the virtualized hosts.

12. The non-transitory computer readable medium of claim 8, further comprising:
storing, by the testbed management service in a database executing in the public cloud, information describing the testbed; and
obtaining, by the test service, the information when executing the tests against the testbed.

13. The non-transitory computer readable medium of claim 8, wherein the testbed management service installs virtualization software on the virtualized hosts.

14. The non-transitory computer readable medium of claim 8, wherein the testbed is configured to expire after a duration, and wherein the testbed management service is configured to renew the testbed prior to expiration for a new duration.

15. A virtualized computing system, comprising:
a public cloud in communication with a data center through a messaging fabric;
a testbed management service, executing in the public cloud, configured to deploy a testbed in the data center, the testbed including an agent platform appliance and endpoint software executing on virtualized hosts of the data center, the agent platform appliance in communication with the endpoint software and the messaging fabric of the public; and
a test service, executing in the public cloud, configured to execute tests against the testbed and verify, in response to results of the tests, operation of cloud services executing in the public cloud and configured to interact with the endpoint software.

16. The virtualized computing system of claim 15, wherein the endpoint software includes a virtual machine (VM) management appliance, the VM management appliance managing virtualization software executing on the virtualized hosts.

17. The virtualized computing system of claim 15, wherein the testbed management service is configured to register the agent platform appliance with a cloud platform of the public cloud, the cloud platform including the cloud services, the testbed management service, the test service, and the messaging fabric.

18. The virtualized computing system of claim 15, wherein the testbed management service is configured to apply, in cooperation with an entitlement service executing in the public cloud, a subscription entitlement for a VM management server of the testbed, the VM management server managing virtualization software executing on the virtualized hosts.

19. The virtualized computing system of claim 15, wherein the testbed management service is configured to store, in a database executing in the public cloud, information describing the testbed, and wherein the test service is configured to obtain the information when executing the tests against the testbed.

20. The virtualized computing system of claim 15, wherein the testbed management service is configured to renew the testbed prior to expiration for a new duration.
